(19) United States
(12) Patent Application Publication
(10) Pub. No.: US 2008/0122785 A1
(43) Pub. Date: May 29, 2008

(54) Portable display with improved functionality

(76) Inventor: John Paul Harmon, Albany, OR (US)

Correspondence Address: Law Offices of Boris G. Tankhilevich, Suite A, 536 North Civic Drive, Walnut Creek, CA, 94597, US

(21) Appl. No.: 11/604,103

(22) Filed: Nov. 25, 2006

(51) Int. Cl. G09G 5/00

(52) U.S. Cl. 345/156; 340/500; 342/357.06; 345/698; 382/181; 382/313; 725/37

(57) ABSTRACT

A method for improving display functionality comprising: (A) detecting movement of a portable display over a physical area by using a motion detector; (B) obtaining a set of data related to the physical area by using an image device; (C) processing the set of data related to the physical area; and (D) displaying the set of data related to the physical area on the portable display, wherein a mode of display is based on a mode of movement of the portable display.

### TECHNICAL FIELD

The present invention relates to the field of portable computers.

### BACKGROUND ART

Hand held computers (and other devices, like cell phones) suffer from inadequate display size simply by being too small. It is difficult to take in an entire construction site map (for instance) on the display of a PDA because of the small size of its display.

What is needed is to improve functionality of a portable display so that the display can access a physical space that is far larger than the physical size of the display per se.

### DISCLOSURE OF THE INVENTION

The present invention provides a method and apparatus that allows one to improve the functionality of a portable display of a portable computer so that the portable display can access a physical space that is far larger than the physical size of the display per se.

One aspect of the present invention is directed to a method for improving display functionality.

In one embodiment, the method of the present invention for improving display functionality comprises: (A) detecting movement of a portable display over a physical area; (B) obtaining a set of data related to the physical area; (C) processing the set of data related to the physical area; and (D) displaying the set of data related to the physical area on the portable display.

In one embodiment of the present invention, the step (A) further comprises: (A1) using a motion detector to detect movement of the portable display over the physical area. In another embodiment of the present invention, the step (A) further comprises: (A2) using a pattern recognition device to detect movement of the portable display over the physical area.

In one embodiment of the present invention, the step (A) further comprises: (A3) selecting the physical area from the group consisting of: {1D physical area; 2D physical area; 3D physical area; 2D physical area perpendicular to the Earth's gravitational field; and 2D physical area parallel with the Earth's gravitational field}.

In one embodiment of the present invention, the step (A) further comprises: (A4) selecting the portable display from the group consisting of: {a Personal Digital Assistant (PDA) display; a laptop display; a digital watch display; a cell phone display; a blackberry-type data device display; a digital camera display; and a digital camcorder display}.

In one embodiment of the present invention, the step (A1) further comprises: (A1, 1) selecting the motion detector from the group consisting of: {an accelerometer; a compass; a gyroscope; and an inertial navigation device}.

In one embodiment of the present invention, the step (A2) further comprises: (A2, 1) selecting the pattern recognition device from the group consisting of: {a digital camera; a digital camcorder; and an optical mouse}.

In one embodiment of the present invention, the step (B) further comprises: (B1) obtaining a set of images of objects located in the physical area by using an image device attached to the portable display; wherein the image device is selected from the group consisting of: {a digital camera; and a digital camcorder}.

In one embodiment of the present invention, the step (B) further comprises: (B2) obtaining a set of data from a database, wherein the set of data from the database is related to the selected physical area.

In one embodiment of the present invention, wherein the portable display is attached to a computer having a processor, a memory, and a local database, the step (B2) further comprises: (B2, 1) programming the processor to select and extract from the local database a set of data related to the selected physical area.

In one embodiment of the present invention, wherein the portable display is attached to a computer having a processor and a memory, and wherein the computer includes a wireless transceiver configured to communicate with a remote database by using a wireless link, the step (B2) further comprises: (B2, 2) programming the processor to communicate with the remote database by using the wireless transceiver and to select and extract from the remote database a set of data related to the selected physical area.

In one embodiment of the present invention, wherein the portable display is attached to a computer having a processor and a memory, the step (C) further comprises: (C1) processing a set of images related to the selected physical area.

In one embodiment of the present invention, wherein the portable display is attached to a computer having a processor, a memory, and a local database, the step (C) further comprises: (C2) processing a set of data obtained from the local database; and (C3) mapping the set of data obtained from the local database to the selected physical area.

In one embodiment of the present invention, wherein the portable display is attached to a computer having a processor, a memory, and a local database, the step (C) further comprises: (C4) superimposing the set of data obtained from the local database and mapped to the selected physical area on the set of images of the selected physical area.

In one embodiment of the present invention, wherein the portable display is attached to a computer having a processor and a memory, wherein the computer includes a wireless transceiver configured to communicate with a remote database by using a wireless link, the step (C) further comprises: (C5) processing a set of data obtained from the remote database, and (C6) mapping the set of data obtained from the remote database to the selected physical area.

In one embodiment of the present invention, wherein the portable display is attached to a computer having a processor and a memory, and wherein the computer includes the wireless transceiver configured to communicate with the remote database by using a wireless link, the step (C) further comprises: (C7) superimposing the set of data obtained from the remote database on the set of images of the physical area.

In one embodiment of the present invention, the step (D) further comprises: (D1) selecting the portable display from the group consisting of: {a time display; a 1D display; a 2D display; a 3D display; a (1D+time) display; a (2D+time) display; and a (3D+time) display}.

In one embodiment of the present invention, the step (D) further comprises: (D2) selecting a mode of display by selecting a mode of movement of the portable display. In one embodiment of the present invention, the step (D2) further comprises: (D2, 1) moving the portable display in the plane perpendicular to the Earth's gravitational field, wherein the portable display displays a set of images related to the selected physical area. In another embodiment of the present invention, the step (D2) further comprises: (D2, 2) moving the portable display in the plane parallel with the Earth's gravitational field, wherein the portable display displays a superimposition of a set of data obtained from the remote (or from the local database) on a set of images of the physical area.

Another aspect of the present invention is directed to a method of viewing selected portions of an image.

In one embodiment, the method of the present invention for viewing selected portions of an image comprises: (A) providing an image to be viewed; (B) providing a display device configured to view at least a part of the image; (C) providing a motion detector in the display device; and (D) providing a processor for interpreting position change detected by the motion detector to access a different part of the displayed view of the image.

In one embodiment of the present invention, the step (D) further comprises: (D1) mapping a set of scale factors to a set of reference points in a displayed view of the image; and (D2) accessing a particular part of the displayed view of the image according to a scale factor mapped to the particular reference point on the image.

One more aspect of the present invention is directed to an apparatus for improving display functionality.

In one embodiment, the apparatus of the present invention for improving display functionality comprises: (A) a means for determining position coordinates of a portable display within a physical area; (B) a means for detecting movement of the portable display over the physical area; (C) a means for obtaining a set of data related to the physical area; (D) a means for processing the set of data related to the physical area; and (E) a means for displaying the set of data related to the physical area.

In one embodiment of the present invention, the means (A) further comprises: a means for selecting the physical area from the group consisting of: {1D physical area; 2D physical area; 3D physical area; 2D physical area perpendicular to the Earth's gravitational field; and 2D physical area parallel with the Earth's gravitational field}. In one embodiment of the present invention, the means (A) further comprises: the position determination device configured to determine position coordinates of the portable display within the selected physical area.

In one embodiment of the present invention, the means (B) further comprises: a motion detector configured to detect movement of the portable display over the physical area. In one embodiment of the present invention, the motion detector further comprises: a motion detector selected from the group consisting of: (an accelerometer; a compass; a gyroscope; and an inertial navigation device).

In one embodiment of the present invention, the means (B) further comprises: a pattern recognition device configured to detect movement of the portable digital over the physical area. In one embodiment of the present invention, the pattern recognition device further comprises: a pattern recognition device selected from the group consisting of: {a digital camera; a digital camcorder; and an optical mouse}.

In one embodiment of the present invention, the means (B) further comprises: a portable display selected from the group consisting of: {a Personal Digital Assistant (PDA) display; a laptop display; a digital watch display; a cell phone display; a blackberry-type data device display; a digital camera display; and a digital camcorder display}.

In one embodiment of the present invention, the means (C) for obtaining the set of data related to the physical area further comprises: an image device attached to the portable display. In one embodiment of the present invention, the image device is selected from the group consisting of: {a digital camera; and a digital camcorder}.

In one embodiment of the present invention, the means (C) for obtaining the set of data related to the physical area further comprises: a database.

In one embodiment of the present invention, wherein the portable display is attached to a computer having a processor and a memory, the database further comprises a local database. In this embodiment of the present invention, the processor is programmed to select and extract from the local database a set of data related to the selected physical area.

In one embodiment of the present invention, wherein the portable display is attached to a computer having a processor and a memory, the database further comprises a remote database. In this embodiment of the present invention, the apparatus further includes a wireless communication device configured to communicate with the remote database by using a wireless link. In this embodiment of the present invention, the processor is programmed to select and extract from the remote database a set of data related to the selected physical area.

In one embodiment of the present invention, wherein the portable display is attached to a computer having a processor and a memory, the means (D) for processing the set of data related to the physical area further comprises a processor configured to process a set of images related to the selected physical area.

In one embodiment of the present invention, wherein the portable display is attached to a computer having a processor, a memory, and a local database, the means (D) further comprises a processor configured to superimpose a set of data obtained from the local database and related to selected physical area on the set of images of the selected physical area.

In one embodiment of the present invention, wherein the portable display is attached to a computer having a processor and a memory, and wherein the computer includes a wireless transceiver configured to communicate with a remote database by using a wireless link, the means (D) further comprises: the processor configured to superimpose a set of data obtained from the remote database and related to selected physical area on the set of images of the physical area.

In one embodiment of the present invention, the means (E) further comprises: (E1) a means for selecting the portable display from the group consisting of: {a time display; a 1D display; a 2D display; a 3D display; a (1D+time) display; a (2D+time) display; and a (3D+time) display}.

In one embodiment of the present invention, the means (E) further comprises: (E1) a switching means configured to switch a mode of display based on a mode of movement of the portable display.

In one embodiment of the present invention, the switching means includes the following algorithm comprising at least the following steps: if the portable display moves in the plane perpendicular to the Earth's gravitational field, the portable display displays a set of images related to the selected physical area; if the portable display moves in the plane parallel with the Earth's gravitational field, the portable display displays a superimposition of a set of data obtained from the remote or the local database on a set of images of the physical area.

An additional aspect of the present invention is directed to an apparatus for displaying selected portions of an image.

In one embodiment, the apparatus of the present invention for displaying selected portions of an image comprises: (A) an image display device configured to view at least a part of the image; (B) a storage means for storing the image; (C) a relative position motion detector configured for determining movements of the display device; and (D) a processor configured to interpret relative position changes in the display device to control a viewing point in the mage, relative to a reference point on the image.

In one embodiment of the present invention, the apparatus for displaying selected portions of an image further comprises: (E) a database of scale-factors including a set of scale factors mapped to a set of reference points in a displayed view of the image; wherein the processor provides an access to a particular part of the displayed view of the image according to a scale factor selected from the database of the scale-factors.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 depicts the apparatus of the present invention for improving display functionality.

FIG. 2 illustrates the basic steps of the method of the present invention for improving display functionality.

FIG. 3 is a flow chart of the switch algorithm that is configured to select a mode of operation of the apparatus of the present invention for improving display functionality.

### BEST MODE FOR CARRYING OUT THE INVENTION

Reference now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific-details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

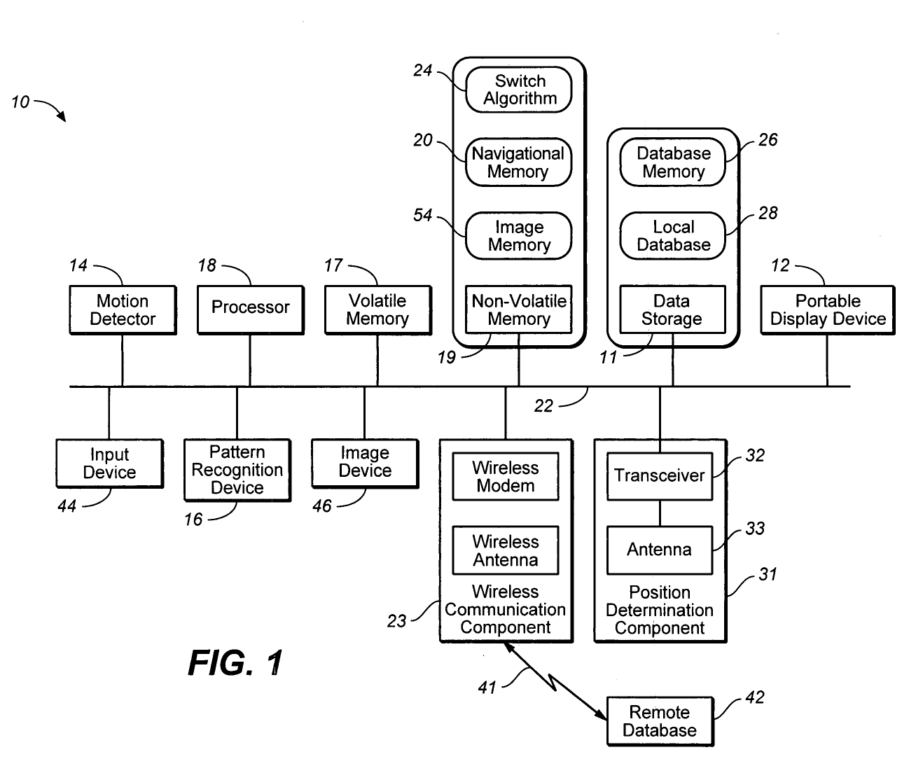

In one embodiment, FIG. 1 depicts the apparatus 10 of the present invention for improving display functionality.

In one embodiment of the present invention, a portable display 12 is selected from the group consisting of: {a Personal Digital Assistant (PDA) display; a laptop display; a digital watch display; a cell phone display; a blackberry-type data device display; a digital camera display; and a digital camcorder display}. According to the Dictionary.com, a Personal Digital Assistant (PDA) is a small hand-held computer typically providing calendar, contacts, and note-taking applications but may include other applications, for example a web browser and a media player. Small keyboards and pen-based input systems are most commonly used for user input.

To access a physical area outside a portable display 12, a user moves the portable display 12 in a physical area. The physical area can comprise: a line (1D physical area), a plane (2D physical area), or a 3D physical area.

### EXAMPLE I

A PDA with improved display functionality (according to the present invention) is placed on a financial page of Wall Street Journal. The PDA can read the financial data published on this page when a user moves the device around the page. It results in a device having a virtual window that has a size much larger than the physical size of the display itself.

### EXAMPLE II

A user moves a device having a display with improved display functionality (according to the present invention) in a plane (2D physical area) perpendicular to the Earth's gravitational field.

### EXAMPLE III

A user moves a device having a display with improved display functionality (according to the present invention) in a plane (2D physical area) parallel with the Earth's gravitational field.

### EXAMPLE IV

A user switches movement of a device having a display with improved display functionality (according to the present invention) between two planes: the first plane is a plane (2D physical area) parallel with the Earth's gravitational field, and the second plane is a plane (2D physical area) perpendicular to the Earth's gravitational field, or vice versa.

Referring still to FIG. 1, in one embodiment of the present invention, the apparatus 10 further comprises a radio-based position determination device 31 further comprising a radio-based transceiver 32 and an antenna 33.

In one embodiment of the present invention, the radio-based position transceiver 32 is selected from the group consisting of: {an autonomous satellite receiver; a Virtual Reference Station (VRS)-based differential satellite positioning system receiver; a Wide Area Augmentation Service (WAAS)-based differential satellite positioning system receiver; a Real Time Kinematic (RTK)-based satellite positioning system receiver; an Omni STAR-High Performance (HP)-based differential satellite positioning system receiver; and a pseudolite receiver}.

In one embodiment of the present invention, the satellite receiver is selected from the group consisting of: {a Global Positioning System (GPS) receiver; a GLONASS receiver, a Global Navigation Satellite System (GNSS) receiver; and a combined GPS-GLONASS receiver}.

The Global Positioning System (GPS) is a system of satellite signal transmitters that transmits information from which an observer's present location and/or the time of observation can be determined. The GPS was developed by the United States Department of Defense (DOD) under its NAVSTAR satellite program. Please, see the document ICD-GPS-200: GPS Interface Control Document, ARINC Research, 1997, GPS Joint Program Office, which is incorporated by reference herein.

The second satellite-based navigation system is the Global Orbiting Navigation Satellite System (GLONASS), placed in orbit by the former Soviet Union and now maintained by the Russian Republic.

As disclosed in the European Commission “White Paper on European transport policy for 2010”, the European Union will develop an independent satellite navigation system GALILEO as a part of a global navigation satellite infrastructure (GNSS).

Reference to a radio positioning system (RADPS) herein refers to a Global Positioning System (GPS), to a Global Orbiting Navigation System (GLONASS), to GALILEO System, and to any other compatible Global Navigational Satellite System (GNSS) satellite-based system that provides information by which an observer's position and the time of observation can be determined, all of which meet the requirements of the present invention, and to a ground based radio positioning system such as a system comprising of one or more pseudolite transmitters.

After the RADPS receiver determines the coordinates of i-th satellite by demodulating the transmitted ephemeris parameters, the RADPS receiver can obtain the solution of the set of the simultaneous equations for its unknown coordinates (x₀, y₀, z₀) and for unknown time bias error (cb). The RADPS receiver can also determine velocity of a moving platform.

Referring still to FIG. 1, in one embodiment of the present invention, the position determination component 31 further comprises a differential GPS receiver (not shown). In differential position determination, many of the errors in the RADPS signals that compromise the accuracy of absolute position determination are similar in magnitude for stations that are physically close. The effect of these errors on the accuracy of differential position determination is therefore substantially reduced by a process of partial error cancellation. Thus, the differential positioning method is far more accurate than the absolute positioning method, provided that the distances between these stations are substantially less than the distances from these stations to the satellites, which is the usual case. Differential positioning can be used to provide location coordinates and distances that are accurate to within a few centimeters in absolute terms. The differential GPS receiver can include: (a) a real time code differential GPS; (b) a post-processing differential GPS; (c) a real-time kinematic (RTK) differential GPS that includes a code and carrier RTK differential GPS receiver.

The differential GPS receiver can obtain the differential corrections from different sources. In one embodiment of the present invention, the differential GPS receiver can obtain the differential corrections from a Base Station (not shown). The fixed Base Station (BS) placed at a known location determines the range and range-rate measurement errors in each received GPS signal and communicates these measurement errors as corrections to be applied by local users. The Base Station (BS) has its own imprecise clock with the clock bias CBBASE. As a result, the local users are able to obtain more accurate navigation results relative to the Base Station location and the Base Station clock. With proper equipment, a relative accuracy of 5 meters should be possible at distances of a few hundred kilometers from the Base Station.

In one embodiment of the present invention, the differential corrections can be obtained from the Wide Area Augmentation System (WAAS) by using the wireless communication device (not shown) and the wireless communication link (not shown). The WAAS system includes a network of Base Stations that uses satellites (initially geostationary satellites-GEOs) to broadcast GPS integrity and correction data to GPS users. The WAAS provides a ranging signal that augments the GPS. Thus, the WAAS ranging signal is designed to minimize the standard GPS receiver hardware modifications. The WAAS ranging signal utilizes the GPS frequency and GPS-type of modulation, including only a Coarse/Acquisition (C/A) PRN code. In addition, the code phase timing is synchronized to GPS time to provide a ranging capability. To obtain the position solution, the WAAS satellite can be used as any other GPS satellite in satellite selection algorithm. The WAAS provides the differential corrections free of charge to a WAAS-compatible user. The accuracy of this method is better than 1 meter.

Referring still to FIG. 1, in one embodiment of the present invention, the position determination component 31 comprises a real time kinematic (RTK) differential GPS receiver that can be used to obtain the position locations with less than 2 cm accuracy.

RTK is a process where GPS signal corrections are transmitted in real time from a reference receiver at a known location to one or more remote rover receivers. The use of an RTK capable GPS system can compensate for atmospheric delay, orbital errors and other variables in GPS geometry, increasing positioning accuracy up to within a centimeter. Used by engineers, topographers, surveyors and other professionals, RTK is a technique employed in applications where precision is paramount. RTK is used, not only as a precision positioning instrument, but also as a core for navigation systems or automatic machine guidance, in applications such as civil engineering and dredging. It provides advantages over other traditional positioning and tracking methods, increasing productivity and accuracy. Using the code phase of GPS signals, as well as the carrier phase, which delivers the most accurate GPS information, RTK provides differential corrections to produce the most precise GPS positioning. The RTK process begins with a preliminary ambiguity resolution. This is a crucial aspect of any kinematic system, particularly in real-time where the velocity of a rover receiver should not degrade either the achievable performance or the system's overall reliability.

Referring still to FIG. 1, in one embodiment of the present invention, the position determination component 31 a differential GPS receiver that can obtain the differential corrections from the Virtual Base Station (VBS) (not shown) by using the wireless communication device 23 and the wireless communication link (not shown).

Indeed, the Virtual Base Station (VBS) is configured to deliver a network-created correction data to a multiplicity of rovers via a concatenated communications link consisting of a single cellular connection, and a radio transmission or broadcasting system. The location of the radio transmitting system can be co-located with a GPS Base Station designated as the position of the local Virtual Reference Station. This GPS Base Station determines its position using GPS, and transmits its location to the VRS Base Station via a cellular link between the local GPS Base Station and the VRS Base Station. It enables the VRS Base Station to generate differential corrections as if such differential corrections were actually being generated at the real GPS Base Station location. An article “Long-Range RTK Positioning Using Virtual Reference Stations,” by Ulrich Vollath, Alois Deking, Herbert Landau, and Christian Pagels, describing VRS in more details, is incorporated herein as a reference in its entirety, and can be accessed at the following URL: http://trl.trimble.com/dscgi/ds.py/Get/File-93152/KIS2001-Paper-LongRange.pdf.

The Omni STAR-HP (High Performance) solution is a dual frequency GPS augmentation service that provides robust and reliable high performance GPS positioning. By using dual frequency GPS observations, Omni STAR-HP can measure the true ionospheric error at the reference station and user location, substantially eliminating this effect in positioning accuracy. Using these iono-free measurements with other information contained in the GPS receiver carrier phase data, the OmniSTAR-HP solution is able to create a wide area positioning solution of unmatched accuracy and performance in selected areas. Published accuracies are 0.2 meter horizontal (Hz) and 0.3 meter vertical (Z).

Referring still to FIG. 1, in one embodiment of the present invention, the position determination component 31 can be implemented by using a pseudolite receiver. The pseudolite comprises a ground based radio positioning system working in any radio frequency including but not limited to the GPS frequencies and the ISM (industrial scientific medical) unlicensed operation band, including 900 MHZ, 2.4 GHz, or 5.8 GHz bands ISM bands, or in a radio location band such as the (9.5-10) GHz band. Pseudolites can be used for enhancing the GPS by providing increased accuracy, integrity, and availability. The complete description of the pseudolite transmitters in GPS band can be found in “Global Positioning System: Theory and Applications; Volume II”, edited by Bradford W. Parkinson and James J. Spilker Jr., and published in Volume 164 in “PROGRESS IN ASTRONAUTICS AND AERONAUTICS”, by American Institute of Aeronautic and Astronautics, Inc., in 1966.

Pseudolites as radio positioning systems can be configured to operate in ISM band. In ISM band, including 900 MHZ, 2.4 GHz, or 5.8 GHz bands, the user can own both ends of the ISM communication system. The ISM technologies are manufactured by Trimble Navigation Limited, Sunnyvale, Calif. Metricom, Los Gatos, Calif. and by Utilicom, Santa Barbara, Calif.

Referring still to FIG. 1, in one embodiment of the present invention, the apparatus 10 further comprises: a motion detector 14 configured to detect movement of the portable display 12 over the physical area. The motion detector is selected from the group consisting of: {an accelerometer; a compass; a gyroscope; and an inertial navigation device}.

In one embodiment of the present invention, the motion detector 14 can be implemented by using one or more accelerometers that are configured to measure movement of the portable display 12. An accelerometer is a sensor that measures acceleration, speed and distance by mathematically determining acceleration over time.

In one embodiment of the present invention, acceleration of the portable display 12 may be measured in each of three perpendicular directions corresponding to the x, y, and z-axes of a Cartesian coordinate system by using accelerometers. In this embodiment, the location of the portable display 12 can be obtained by processing the measured acceleration, speed and distance of the portable display by using the processor 18 and a memory block. The processor 18 may be implemented by using a commercially available or custom made microprocessor. The memory includes a volatile memory 17, a non-volatile memory 19, and data storage 11, and can be implemented by using the following types of devices: cache, ROM, PROM, EPROM, EEPROM, flash, SRAM, and DRAM.

In another embodiment of the present invention, accelerations of the portable display 12 may be measured for six degrees-of-freedom by using a number of accelerometers, wherein three accelerations may be measured corresponding to the x, y, and z-axes of a Cartesian coordinate system, and wherein three additional accelerations may be measured corresponding to pitch, roll, and rotation.

For example, the motion detector 14 can be implemented by using at least one relatively inexpensive (˜$10) and having a relatively high resolution (50 micro gravities per root hertz) accelerometer. Accelerometers based on silicon-micromachined MEMS technology exploit the changes in capacitance caused by the relative movement of moving and fixed structures created in the silicon, using wafer-processing techniques. STMicroelectronics (NYSE: STM) manufactures a MEMS-based three-axis accelerometer device LIS3L02D that provides both three-axis sensing in a single package and a digital output. This device is designed primarily for handheld terminals where it can be used to implement a motion-based user interface that is based on hand movements, allowing one-handed operation without styli, thumb keyboards or other input devices. The LIS3L02D includes a single-chip MEMS sensor chip plus a calibrated interface chip that senses changes in capacitance in the sensor and translates them into SPI or I2C serial digital outputs. The LIS3L02D operates on a 2.7 to 3.6V supply voltage. The device has an equivalent noise acceleration of better than 500 millionths of one ‘g’. During transport and service it can withstand accelerations up to 3000 g without damage.

In one embodiment of the present invention, the motion detector 14 can be implemented by using a compass configured to provide direction information of the movement of the display 12, and/or gyroscope configured to measure rotational movement of the portable display 12. These two measurements can be used to supplement and/or replace the information obtained by using at least one accelerometer.

In one embodiment of the present invention, the motion detector 14 can be implemented by using an inertial navigation device that can be built by using a combination of accelerometers, magnetometers, a processor, and specifically designed software.

Acceleron Technology, Inc., located in San Francisco, Calif., has built small light weight, inertial navigation device using three accelerometers to measure three components of the local acceleration vector, three magnetometers to measure three components of the local gravitational vector, plus some software.

A magnetometer is a device that measures a local magnetic field. The local gravitational factor can be calculated by using the measured local magnetic field, because the local gravitational field, as well as the local magnetic field, are both defined by the local Earth geometry, as well explained in the book “Applied Mathematics in Integrated Navigation Systems”, published by American Institute of Aeronautics and Astronautics, Inc, 2000, by Robert M. Rogers.

Indeed, the “Applied Mathematics in Integrated Navigation Systems” teaches how geometrical shape and gravitational models for representing the Earth are used to provide relationship between ECEF position x-y-z components and local-level latitude, longitude, and attitude positions. The “Applied Mathematics in Integrated Navigation Systems” also teaches how a moving person/object's position change in geographical coordinates is related to the local Earth relative velocity and Earth curvature. The “Applied Mathematics in Integrated Navigation Systems” also teaches how to develop the functional characteristics of inertial sensors used in navigation systems, how to develop the time-varying dynamic error models for inertial sensors random errors. The “Applied Mathematics in Integrated Navigation Systems” is incorporated herein in its entirety.

Thus, in one embodiment of the present invention, the processor 18 is configured to process a set of positional data related to the portable display 12 based on the acceleration data adjusted for the local gravitational factor provided by the inertial navigation device 14.

Referring still to FIG. 1, in one embodiment of the present invention, the motion detector further comprises a pattern recognition device 16 configured to detect movement of the portable display 12 over the selected physical area. In one embodiment of the present invention, the pattern recognition device 16 is selected from the group consisting of: {a digital camera; a digital camcorder; and an optical mouse}.

The concept of pattern has emerged from sensorial perception. A set of perceptual measurements of the visual or auditory system that is “easily” recognizable is traditionally referred to as a pattern. Images of random pixels would not be considered “patterns” while images of simple line shapes like characters would. The so-called “raw data” is the set of measurements provided by a sensor (e.g. the pixels of an image provided by a digital camera). The main steps of the pattern recognition process are pre-processing and feature extraction that may include some signal processing such as smoothing and noise filtering and the extraction of higher level features for which human knowledge about the task is essential.

Referring still to FIG. 1, in one embodiment of the present invention, the pattern recognition device 16 (implemented by using a digital camera) can obtain a sequence of images of the background surrounding the portable display 12, whereas the processor 18 and memory (pre-loaded with the pattern recognition software) can perform the task of detecting movement of the portable display 12.

Similarly, in one embodiment of the present invention, the pattern recognition device 16 (implemented by using a camcorder) can obtain a sequence of video images of the background surrounding the portable display 12. Again, the processor 18 and memory (pre-loaded with the pattern recognition software) can perform the task of detecting movement of the portable display 12.

In one more embodiment of the present invention, the pattern recognition device 16 (implemented by using an optical mouse) can obtain a sequence of video images of the background surrounding the portable display 12.

The optical mouse developed by Agilent Technologies, actually uses a tiny camera to take 1,500 pictures every second. Able to work on almost any surface, the mouse has a small, red light-emitting diode (LED) that bounces light off that surface onto a complementary metal-oxide semiconductor (CMOS) sensor. The CMOS sensor sends each image to a digital signal processor (DSP) for analysis. The DSP, operating at 18 MIPS (million instructions per second), is able to detect patterns in the images and see how those patterns have moved since the previous image. Based on the change in patterns over a sequence of images, the DSP determines how far the mouse has moved and sends the corresponding coordinates to the computer.

For the purposes of the present invention, the pattern recognition device 16 can be implemented by using an optical mouse, wherein the processor 18 is configured to perform the DSP operations to detect movement of the portable display 12.

Referring still to FIG. 1, in one embodiment, the apparatus 10 of the present invention further comprises an image device 46 configured to obtain a plurality of images of the background of the selected physical area. In one embodiment of the present invention, the image device 46 is selected from the group consisting of: {a digital camera; and a digital camcorder}. A digital camera (as well as a digital camcorder) is a device well-known to a person skilled in the art. In one embodiment of the present invention, the processor 18 is configured to process the plurality of images of the selected physical area obtained by the image device 46 and to store them in the memory.

Referring still to FIG. 1, in one embodiment, the apparatus 10 of the present invention further comprises the data storage memory 11 coupled to the processor 18 via the bus 22 further comprising the database memory 26 and the local database 28.

In one embodiment of the present invention, the local database 28 is pre-loaded with data related to the selected physical area. In one example, the local database 28 is pre-loaded with the images of buildings to be built in the selected physical area. In another example, the local database 28 is pre-loaded with the existing buildings and streets (with addresses and names on them) located in the selected physical area.

In one embodiment of the present invention, the processor 18 is programmed to select and extract from the local database 28 a set of data related to the selected physical area, and to store this set of data in the database memory 26. The processor 18 communicates with the database memory 26 via the address/data bus 22.

In one embodiment of the present invention, the processor 18 is configured to send to the input device 44 a set of images of the selected physical area obtained by the image device 46 and stored in the memory.

In another embodiment of the present invention, the processor 18 is configured to superimpose a set of data stored in the database memory 26 (obtained from the local database 28 and related to selected physical area) on the set of images of the physical area obtained by the image device 46 and stored in the memory and to send this set of superimposed data to the input device 44.

Referring still to FIG. 1, in one embodiment, the apparatus of the present invention 10 is configured to display selected portions of an image. In this embodiment of the present invention, the database 28 includes a database of scale-factors, and the processor 18 is configured to map a set of scale factors to a set of reference points in a displayed view of the image. In this embodiment of the present invention, the processor 18 is also configured to interpret relative position changes in the display device 12 to control a viewing point in the mage, relative to a reference point on the image. In this embodiment of the present invention, the processor 18 is also configured to select a particular scale factor from the database of the scale-factors, and to access a particular part of the displayed view of the image according to the selected scale factor.

In one embodiment, referring still to FIG. 1, the apparatus 10 of the present invention further includes the wireless communication device 23 configured to communicate with the remote database 42 by using the wireless link 41. The wireless link 41 can be implemented by using a wireless link selected from the group consisting of: {a cellular link; a radio link; a private radio band link; a SiteNet 900 private radio network link; a link to the wireless Internet; and a satellite wireless communication link}.

In one embodiment of the present invention, the processor 18 is programmed to select and extract from the remote database 42 a set of data related to the selected physical area by using the wireless communication device 23 and place this set of data in the database memory 26.

In one embodiment of the present invention, the processor 18 is configured to superimpose a set of data stored in the database memory 26 (obtained from the remote database 42 and related to selected physical area) on the set of images of the physical area obtained by the image device 46, and to send this set of superimposed data to the input device 44.

In one embodiment of the present invention, the input device 44 is programmed to input data to the portable display 12 by using the switch algorithm 24 that is connected to the processor 18 via bus 22.

In one embodiment of the present invention, the switch algorithm 24 (of FIG. 1) comprises at least the following steps: if the portable display 12 moves in the plane perpendicular to the Earth's gravitational field, the portable display 12 displays a set of images related to the selected physical area; if the portable display 12 moves in the plane parallel with the Earth's gravitational field, the portable display 12 displays a set of superimposed data obtained from the remote (or the local database) on a set of images of the selected physical area.

More specifically, in the first mode of operation of the present invention, the display 12 is flying (by a user) as a “virtual window” over an unlimited “full display” physical area. The image device 46 is configured to obtain the images of the background of the physical area while the motion detector 14 (or pattern recognition detector 16) detects movement of the portable display. This gives the user access to a view that is physically larger than the view made possible by the size of the unit.

In the second mode of operation of the present invention, the display 12 pays attention to all three dimensions (3D) of the input. When the display 12 device is flying (by a user) as a “virtual window” over an unlimited physical area perpendicular to the Earth's gravitational field, it operates in a “full display” physical area mode described in the paragraph above.

On the other hand, when the display 12 is moved up into a position parallel with the Earth's gravitational field, it switches to a mode that paints a data filled picture of the user's surroundings. More specifically, the user could access images derived from a database, either from the remote database 42, or from the local database 28. In one embodiment, these images can be superimposed on the natural background of the physical area.

In one embodiment of the present invention, referring still to FIG. 1, the portable display 12 can be selected from the group consisting of: {a time display; a 1D display; a 2D display; a 3D display; a (1D+time) display; a (2D+time) display; and a (3D+time) display}.

### EXAMPLE V

A “time display” is essentially a recording device with improved functionality that is configured to record the set of images of the selected physical area per se, and/or the set of images corresponding to the selected physical area and superimposed on the set of images of the selected physical area.

### EXAMPLE VI

A “1D display” is a linear real time display with improved functionality that is configured to display the set of linear images (data) of the selected physical area per se, and/or the set of linear images (data) corresponding to the selected physical area and superimposed on the set of linear images (data) of the selected physical area.

### EXAMPLE VII

A “2D display” is a 2D real time display with improved functionality that is configured to display the set of 2D images (and/or data) of the selected physical area per se, and/or the set of 2D images (and/or data) corresponding to the selected physical area and superimposed on the set of 2D images (and/or data) of the selected physical area.

### EXAMPLE VIII

A “3D display” is a 3D real time display with improved functionality that is configured to display the set of (2D images+data) of the selected physical area per se, and/or the set of (2D images+data) corresponding to the selected physical area and superimposed on the set of (2D images+data) of the selected physical area.

### EXAMPLE IX

A “1D+time” display is a linear real time display with improved functionality plus with recording capabilities, that is configured: (A) to display in real time the set of linear images (data) of the selected physical area per se; or (B) to record and display later in time the set of linear images (data) of the selected physical area per se; or (C) to display in real time the set of linear images (data) corresponding to the selected physical area and superimposed on the set of linear images (data) of the selected physical area; or (D) to record and display later in time the set of linear images (data) corresponding to the selected physical area and superimposed on the set of linear images (data) of the selected physical area.

### EXAMPLE X

A “2D+time” display is a 2D real time display with improved functionality plus with recording capabilities, that is configured: (A) to display in real time the set of 2D images of the selected physical area per se; or (B) to record and display later in time the set of 2D images of the selected physical area per se; or (C) to display in real time the set of 2D images corresponding to the selected physical area and superimposed on the set of 2D images of the selected physical area; or (D) to record and display later in time the set of 2D images corresponding to the selected physical area and superimposed on the set of 2D images of the selected physical area.

### EXAMPLE XI

A “3D+time” display is a 3D real time display with improved functionality plus with recording capabilities, that is configured: (A) to display in real time the set of (2D images+data) of the selected physical area per se; or (B) to record and display later in time the set of (2D images+data) of the selected physical area per se; or (C) to display in real time the set of (2D images+data) corresponding to the selected physical area and superimposed on the set of 2D images of the selected physical area; or (D) to record and display later in time the set of (2D images+data) corresponding to the selected physical area and superimposed on the set of 2D images of the selected physical area.

In one embodiment, the method of the present invention to improve the functionality of the portable display can be performed by using the apparatus 10 of FIG. 1.

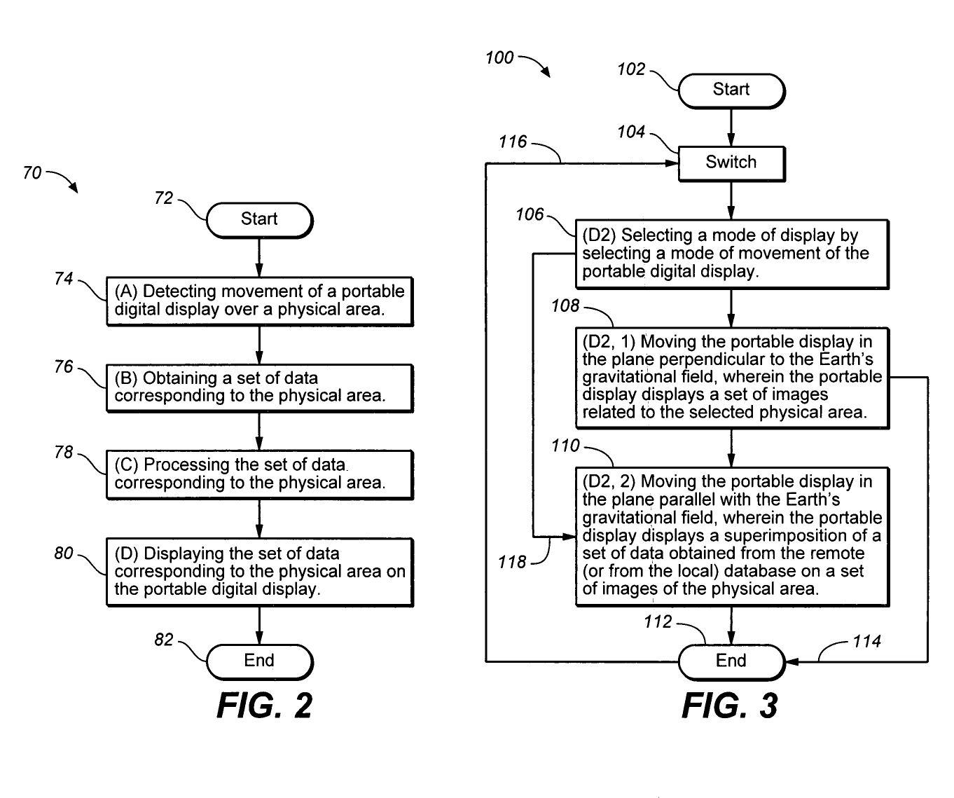

FIG. 2 illustrates the basic steps of the method 70 of the present invention for improving display functionality comprising: (A) detecting movement of the portable display 12 over the selected physical area (step 74); (B) obtaining a set of data related to the selected physical area (step 76); (C) processing the set of data related to the selected physical area (step 78); and (D) displaying the set of data related to the physical area on the portable display 12 (step 80).

In one embodiment of the present invention, the step (A) further comprises (not shown): (A1) using a motion detector (14 of FIG. 1) to detect movement of the portable display 12 over the selected physical area. In another embodiment of the present invention, the step (A) further comprises: (A2) using a pattern recognition device (16 of FIG. 1) to detect movement of the portable display 12 over the selected physical area.

In one embodiment of the present invention, the step (A) further comprises (not shown): (A4) selecting the portable display from the group consisting of: {a Personal Digital Assistant (PDA) display; a laptop display; a digital watch display; a cell phone display; a blackberry-type data device display; a digital camera display; and a digital camcorder display}.

In one embodiment of the present invention, the step (A1) further comprises (not shown): (A1, 1) selecting the motion detector (14 of FIG. 1) from the group consisting of: {an accelerometer; a compass; a gyroscope; and an inertial navigation device}.

In one embodiment of the present invention, the step (A2) further comprises (not shown): (A2, 1) selecting the pattern recognition device (16 of FIG. 1) from the group consisting of: {a digital camera; a digital camcorder; and an optical mouse}.

In one embodiment of the present invention, the step (B) further comprises (not shown): (B1) obtaining a set of images of objects located in the physical area by using the image device (46 of FIG. 1) attached to the portable display (12 of FIG. 1); wherein the image device is selected from the group consisting of: {a digital camera; and a digital camcorder}.

In one embodiment of the present invention, the step (B) further comprises (not shown): (B2) obtaining a set of data from a database, wherein the set of data from the database is related to the selected physical area.

In one embodiment of the present invention, the step (B2) further comprises (not shown): (B2, 1) programming the processor (18 of FIG. 1) to select and extract from the local database (28 of FIG. 1) a set of data related to the selected physical area.

In one embodiment of the present invention, the step (B2) further comprises (not shown): (B2, 2) programming the processor (18 of FIG. 1) to communicate with the remote database (42 of FIG. 1) by using the wireless communication device (23 of FIG. 1) and to select and extract from the remote database (42 of FIG. 1) a set of data related to the selected physical area.

In one embodiment of the present invention, the step (C) further comprises (not shown): (C2) processing a set of data obtained from the local database (28 of FIG. 1); and (C3) mapping the set of data obtained from the local database (28 of FIG. 1) to the selected physical area. The step of mapping can be performed by using the processor 18 of FIG. 1.

In one embodiment of the present invention, the step (C) further comprises (not shown): (C4) superimposing the set of data obtained from the local database (28 of FIG. 1) and mapped to the selected physical area on the set of images of the selected physical area.

In one embodiment of the present invention, the step (C) further comprises (not shown): (C5) processing a set of data obtained from the remote database (42 of FIG. 1), and (C6) mapping the set of data obtained from the remote database to the selected physical area.

In one embodiment of the present invention, the step (C) further comprises (not shown): (C7) superimposing the set of data obtained from the remote database (42 of FIG. 1) on the set of images of the physical area.

In one embodiment of the present invention, the step (D) further comprises (not shown): (D1) selecting the portable display (12 of FIG. 1) from the group consisting of: {a time display; a 1D display; a 2D display; a 3D display; a (1D+time) display; a (2D+time) display; and a (3D+time) display}.

FIG. 3 is a flow chart 100 of the switch algorithm of the present invention that is configured to select a mode of operation of the apparatus (10 of FIG. 1) of the present invention for improving display functionality.

In one embodiment of the present invention, the step (D) further comprises: (D2) (step 106 of FIG. 3) selecting a mode of display by selecting a mode of movement of the portable display.

In one embodiment of the present invention, the step (D2) further comprises: (D2, 1) (step 108 of FIG. 3) moving the portable display in the plane perpendicular to the Earth's gravitational field, wherein the portable display displays a set of images related to the selected physical area.

In another embodiment of the present invention, the step (D2) further comprises: (D2, 2) (step 110 of FIG. 3) moving the portable display in the plane parallel with the Earth's gravitational field, wherein the portable display displays a superimposition of a set of data obtained from the remote (or from the local database) on a set of images of the physical area.

In one embodiment, the method of the present invention of viewing selected portions of an image can be performed by using the apparatus 10 of FIG. 1.

In one embodiment, the method of the present invention for viewing selected portions of an image comprises (not shown): (A) providing an image to be viewed; (B) providing the display device (12 of FIG. 1) configured to view at least a part of the image; (C) providing the motion detector (14 of FIG. 1) in the display device; and (D) providing the processor (18 of FIG. 1) for interpreting position change detected by the motion detector to access a different part of the displayed view of the image.

In one embodiment of the present invention, the step (D) further comprises: (D1) mapping a set of scale factors to a set of reference points in a displayed view of the image by using the processor 18 and the memory; and (D2) accessing a particular part of the displayed view of the image according to a scale factor mapped to the particular reference point on the image.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents

What is claimed is:

1. A method for improving display functionality, comprising:
(A) detecting movement of a portable display over a physical area;
(B) obtaining a set of data related to said physical area;
(C) processing said set of data related to said physical area;
and
(D) displaying said set of data related to said physical area on said portable display.

2. The method of claim 1, wherein said step (A) further comprises:
(A1) using a motion detector to detect movement of said portable display over said physical area.

3. The method of claim 1, wherein said step (A) further comprises:
(A2) using a pattern recognition device to detect movement of said portable display over said physical area.

4. The method of claim 1, wherein said step (A) further comprises:
(A3) selecting said physical area from the group consisting of: {1D physical area; 2D physical area; 3D physical area; 2D physical area perpendicular to the Earth's gravitational field; and 2D physical area parallel with the Earth's gravitational field}.

5. The method of claim 1, wherein said step (A) further comprises:
(A4) selecting said portable display from the group consisting of: {a Personal Digital Assistant (PDA) display; a laptop display; a digital watch display; a cell phone display; a blackberry-type data device display; a digital camera display; and a digital camcorder display}.

6. The method of claim 2, wherein said step (A1) further comprises:
(A1, 1) selecting said motion detector from the group consisting of: {an accelerometer; a compass; a gyroscope; and an inertial navigation device}.

7. The method of claim 3, wherein said step (A2) further comprises:
(A2, 1) selecting said pattern recognition device from the group consisting of: {a digital camera; a digital camcorder; and an optical mouse}.

8. The method of claim 1, wherein said step (B) further comprises:
(B1) obtaining a set of images of objects located in said physical area by using an image device attached to said portable display; wherein said image device is selected from the group consisting of: {a digital camera; and a digital camcorder}.

9. The method of claim 1, wherein said step (B) further comprises:
(B2) obtaining a set of data from a database, wherein said set of data from said database is related to said physical area.

10. The method of claim 9, wherein said portable display is attached to a computer having a processor, a memory, and a local database; and wherein said step (B2) further comprises:
(B2, 1) programming said processor to select and extract from said local database a set of data related to said physical area.

11. The method of claim 9, wherein said portable display is attached to a computer having a processor and a memory, wherein said computer includes a wireless transceiver configured to communicate with a remote database by using a wireless link, and wherein said step (B2) further comprises:
(B2, 2) programming said processor to communicate with said remote database by using said wireless transceiver and to select and extract from said remote database a set of data related to said physical area.

12. The method of claim 1, wherein said portable display is attached to a computer having a processor and a memory, and wherein said step (C) further comprises:
(C1) processing a set of images related to said physical area.

13. The method of claim 1, wherein said portable display is attached to a computer having a processor, a memory, and a local database; and wherein said step (C) further comprises:
(C2) processing a set of data obtained from said local database;
and
(C3) mapping said set of data obtained from said local database to said physical area.

14. The method of claim 13 further comprising:
(C4) superimposing said set of data obtained from said local database and mapped to said physical area on said set of images of said physical area.

15. The method of claim 1, wherein said portable display is attached to a computer having a processor and a memory, wherein said computer includes a wireless transceiver configured to communicate with a remote database by using a wireless link, and wherein said step (C) further comprises:
(C5) processing a set of data obtained from said remote database;
and
(C6) mapping said set of data obtained from said remote database to said physical area.

16. The method of claim 15 further comprising:
(C7) superimposing said set of data obtained from said remote database on said set of images of said physical area.

17. The method of claim 1, wherein said step (D) further comprises:
(D1) selecting said portable display from the group consisting of: {a time display; a 1D display; a 2D display; a 3D display; a (1D+time) display; a 1D+time) display; and a (3D+time) display}.

18. The method of claim 1, wherein said step (D) further comprises:
(D2) selecting a mode of display by selecting a mode of movement of said portable display.

19. The method of claim 18, wherein said step (D2) further comprises:
(D2, 1) moving said portable display in the plane perpendicular to the Earth's gravitational field, wherein said portable display displays a set of images related to said physical area.

20. The method of claim 18, wherein said step (D2) further comprises:
(D2, 2) moving said portable display in the plane parallel with the Earth's gravitational field, wherein said portable display displays a superimposition of a set of data obtained from said database on a set of images of said physical area.

21. A method of viewing selected portions of an image, comprising:
(A) providing an image to be viewed;
(B) providing a display device configured to view at least a part of said image;
(C) providing a motion detector in said display device;
and
(D) providing a processor for interpreting position change detected by said motion detector to access a different part of the displayed view of said image.

22. The method of claim 21, wherein said step (D) further comprises:
(D1) mapping a set of scale factors to a set of reference points in a displayed view of said image;
and
(D2) accessing a particular part of said displayed view of said image according to a scale factor mapped to said particular reference point on said image.

23. An apparatus for improving display functionality comprising:
(A) a means for determining position coordinates of said apparatus within a physical area;
(B) a means for detecting movement of a portable display over said physical area;
(C) a means for obtaining a set of data related to said physical area;
(D) a means for processing said set of data related to said physical area;
and
(E) a means for displaying said set of data related to said physical area.

24. The apparatus of claim 23, wherein said means (A) for determining position coordinates of said apparatus within said physical area further comprises:
a means for selecting said physical area from the group consisting of: {1D physical area; 2D physical area; 3D physical area; 2D physical area perpendicular to the Earth's gravitational field; and 2D physical area parallel with the Earth's gravitational field}.

25. The apparatus of claim 23, wherein said means (A) for determining position coordinates of said apparatus within said physical area further comprises:
a position determination device configured to determine position coordinates of said apparatus within said physical area.

26. The apparatus of claim 23, wherein said means (B) for detecting movement of said portable display over said physical area further comprises:
a motion detector configured to detect movement of said portable display over said physical area.

27. The apparatus of claim 26, wherein said motion detector further comprises:
a motion detector selected from the group consisting of: {an accelerometer;
a compass; a gyroscope; and an inertial navigation device}.

28. The apparatus of claim 23, wherein said means (B) for detecting movement of said portable display over said physical area further comprises:
a pattern recognition device configured to detect movement of said portable digital over said physical area.

29. The apparatus of claim 28, wherein said pattern recognition device further comprises:
a pattern recognition device selected from the group consisting of: {a digital camera; a digital camcorder; and an optical mouse}.

30. The apparatus of claim 23, wherein said means (C) for obtaining said set of data related to said physical area further comprises:
an image device attached to said portable display; wherein said image device is selected from the group consisting of: {a digital camera; and a digital camcorder}.

31. The apparatus of claim 23, wherein said means (C) for obtaining said set of data related to said physical area further comprises:
a database.

32. The apparatus of claim 31, wherein said portable display is attached to a computer having a processor and a memory, and wherein said database further comprises:
a local database; wherein said processor is programmed to select and extract from said local database a set of data related to said physical area.

33. The apparatus of claim 31, wherein said portable display is attached to a computer having a processor and a memory, and wherein said database further comprises:
a remote database; and wherein said computer further includes a wireless transceiver configured to communicate with said remote database by using a wireless link; and wherein said processor is programmed to select and extract from said remote database a set of data related to said physical area.

34. The apparatus of claim 23, wherein said portable display is attached to a computer having a processor and a memory, and wherein said means (D) for processing said set of data related to said physical area further comprises:
said processor configured to process a set of images related to said physical area.

35. The apparatus of claim 23, wherein said portable display is attached to a computer having a processor, a memory, and a local database; and wherein said means (D) for processing said set of data related to said physical area further comprises:
said processor configured to superimpose a set of data obtained from said local database and related to physical area on said set of images of said physical area.

36. The apparatus of claim 23, wherein said portable display is attached to a computer having a processor and a memory, wherein said computer includes a wireless transceiver configured to communicate with a remote database by using a wireless link, and wherein said means (D) for processing said set of data related to said physical area further comprises:
said processor configured to superimpose a set of data obtained from said remote database and related to physical area on said set of images of said physical area.

37. The apparatus of claim 23, wherein said means (E) further comprises:
a means for selecting said portable display from the group consisting of: {a time display; a 1D display; a 2D display; a 3D display; a (1D+time) display; a (2D+time) display; and a (3D+time) display}.

38. The apparatus of claim 23, wherein said means (E) further comprises:
a switching means configured to switch a mode of display based on a mode of movement of said portable display; said switching means including the following algorithm comprising at least the following steps:
if said portable display moves in the plane perpendicular to the Earth's gravitational field, said portable display displays a set of images related to said physical area;
if said portable display moves in the plane parallel with the Earth's gravitational field, said portable display displays a superimposition of a set of data obtained from said remote or said local database on a set of images of said physical area.

39. An apparatus for displaying selected portions of an image, comprising:
(A) an image display device configured to view at least a part of said image;
(B) an image memory configured to store an image;
(C) a relative position motion detector configured for determining movements of said display device;
and
(D) a processor configured to interpret relative position changes n said display device to control a viewing point in said mage, relative to a reference point on said image.

40. The apparatus of claim 39 further comprising:
(E) a database of scale-factors including a set of scale factors mapped to a set of reference points in a displayed view of said image; wherein said processor provides an access to a particular part of said displayed view of said image according to a scale factor in said database of scale-factors.

41. An apparatus for improving display functionality comprising:
a display device coupled with a bus, said display device configured to display a first portion of accessed data;
a memory coupled with said bus;
a motion detector coupled with said bus for sensing movement of said apparatus along a plane of motion;
and
a processor coupled with said bus, said processor causing said display device to display a second portion of accessed data in response to receiving an indication of movement from said motion detector.

42. The apparatus of claim 41, wherein said motion detector is selected from the group consisting of: {an accelerometer; a compass; a gyroscope; and an inertial navigation device}.

43. The apparatus of claim 41, wherein said motion detector is configured to determine a vector between a first location of said apparatus and a second location of said apparatus and wherein said processor determines said second portion of said accessed data based upon said determining of said vector.

44. The apparatus of claim 41 further comprising:
a position determining component coupled with said bus for determining a first geographic position of said apparatus.

45. The apparatus of claim 44, wherein said processor determines a second geographic position of said apparatus based upon said vector and said first geographic position.
